(19) United States
(12) Patent Application Publication
(10) Pub. No.: US 2023/0304622 A1
(43) Pub. Date: Sep. 28, 2023

(54) IMPROVEMENTS IN PIPELINE NETWORKS

(71) Applicant: PIPE TRANSFORMATIONS LTD, London (GB)

(72) Inventor: Colin Patterson, Manilla (PH)

(21) Appl. No.: 18/021,314

(22) PCT Filed: Aug. 16, 2021
(86) PCT No.: PCT/GB2021/052119

§ 371 Date: Feb. 14, 2023

(30) Foreign Application Priority Data
Aug. 14, 2020 (GB) 2012710.6

(51) Int. Cl. F16L 55/11; F16L 55/115; F16K 3/02

(52) U.S. Cl. CPC F16L 55/11; F16L 55/115; F16K 3/02

(57) ABSTRACT

A pipeline network includes at least one housing comprising a riser and a pipeline connector, the housing adapted to receive a device configured to interact with fluid flowing through the pipeline connector. The riser is provided with a riser closure member that is attachable removably to the riser, and a seal adapted to provide a fluid tight seal between the riser and the riser closure member.

### FIELD FOR THE INVENTION

The present invention relates to pipeline networks, and in particular to pipe networks that include valves and/or require monitoring.

### BACKGROUND OF THE INVENTION

Pipeline networks are used to convey fluids (liquids and gases). Such fluids may be distributed to end users through a complex network of pipes. The pipeline networks include valves to control flow and direct the flow of water to particular parts of the network. Typically, a pipeline network includes shut off valves, control valves and the like to accommodate isolation of sections within the network, flow control valves for controlling flow of fluid through the network, etc. Shut off valves (also known as isolation valves) are typically used in either a fully open or fully closed configuration. A shut off valve that is typically open, may be closed if it necessary to stop the flow of fluid for normal distribution or processing reasons and also so that a section can be isolated from the fluid flow, for example so that a repair may be carried out. A shut off valve that is typically closed may be opened to divert the flow of fluid through a different part of the pipeline network, for example if there is a leak in one part of the network, one or more shut off valves may be opened or closed to divert fluid through a different part of the network, thereby avoiding the leaking section of pipe.

In the field of pipeline networks various parameters relating to the fluid flowing through the pipeline network may be monitored. This is known in the art. the Applicant described. In patent application published under number GB2559998, the Applicant describes a pipeline apparatus comprising a housing including a riser and a pipeline connector and a device configured to interact with fluid flowing through the pipeline connector, a mounting means for releasably mounting the device in the riser and seal means situated between an inner surface of the riser and an outer surface of the mounting means, the seal means configured to seal against egress of fluid from the apparatus, the mounting means and the riser each including a part of a locking means for releasably locking the device in the riser, the device situated in the pipeline connector; wherein the apparatus further comprises a signal processor electrically connected to the device, and wherein when the device is mounted in the riser at least a part of said device extends into the pipeline connector for interaction with the fluid flowing through said pipeline connector.

In GB2559998 the device may be configured for sensing various parameters including amongst others a parameter selected from the group comprising, but not limited to: flow, temperature, chlorine content, dissolved oxygen, pH, oxidation reduction potential, conductivity, colour, turbidity, and pressure. The sensor may include various components such as a pump, a generator and the sensor may be configured for sensing any number of parameters and dynamics within the flow.

GB2559998 established that where a valve body may be removed easily from a riser, the valve body may be replaced with a piece of monitoring equipment.

The shut off valves situated in pipe networks are relatively expensive items. One problem associated with shut-off valves is that in many situations they are used so infrequently that when there is a need to move the shut off valve between the open and closed configurations the shut off valve is seized in either the closed or open state and cannot be moved, or the seals and seats have deteriorated to such an extent that the valve cannot function.

The applicant described an apparatus and method for retrieving components from a pipeline under pressure in its patent number GB2517308.

Improving a pipeline network to address the problem associated with non-functioning valves would be desirable. It would also be desirable to improve the capacity and efficiency of monitoring pipeline condition and flow parameters.

### SUMMARY OF THE INVENTION

It has been found that in many pipelines, whilst there is a requirement for shut off valves periodically, the occasions when shut off valves are required to change from open to closed or closed to open in many installations seldom occur. Instead of providing a shut-off valve in the pipeline, it would be advantageous to provide a housing that is configured to receive a valve body so that a valve body may be inserted into the housing when there is a need to close off flow through the pipeline. If the housing may be sealed without a valve being situated in the housing, then a valve body may be taken to and inserted into the housing when there is a need to close the pipeline. In this way the valve may be stored in an environment where the valve is not likely to corrode. If the valve and housing can be arranged such that a valve may be fitted in a housing relatively quickly (minutes not hours) and more preferably without turning off the flow of fluid through the pipeline, then the concept described herein will be effective and useful.

The number of shut off valves required at any particular moment is likely to be fewer than number of locations in a pipeline where a shut off valve or piece of monitoring equipment may be needed at some point in time. By providing an apparatus where for most of the time a housing to receive a valve or piece of monitoring equipment is provided instead of a shut off valve or piece of monitoring equipment in the pipeline, not only are fewer valves or pieces of monitoring equipment needed, but also, the valves or pieces of monitoring equipment can be stored in a suitable environment and can be checked before deployment.

According to a first aspect of the invention there is provided a pipeline network including at least one housing comprising a riser and a pipeline connector, the housing adapted to receive a device configured to interact with fluid flowing through the pipeline connector, the device removable from the housing, the riser provided with a riser closure member that is attachable removably to the riser, and a seal adapted to provide a fluid tight seal against egress of fluid from the pipeline connector via the riser wherein the or each at least one housing has attached thereto a selected one of the device and the riser closure member.

According to another aspect of the invention there is provided a pipeline network including at least one housing comprising a riser and a pipeline connector, the housing adapted to receive a device configured to interact with fluid flowing through the pipeline connector, the riser provided with a riser closure member that is attachable removably to the riser, and a seal adapted to provide a fluid tight seal between the riser and the riser closure member, the housing occupied by one of the riser closure member and the device configured to interact with fluid flowing through the pipeline connector.

The riser closure member may comprise an insert that is removably attachable to the riser. Advantageously, the insert is shaped and dimensioned such that the riser is closed off and the fluid pathway through the pipeline connector is similar to the shape and dimensions of the pipeline.

The riser may includes a riser foot which opens up into the pipeline connector. The riser closure member may include a blanking element. The blanking element may be configured to close off the foot of the riser. A seal may be provided between the blanking element and a wall of the housing at the foot of the riser.

The blanking element may extend into the pipeline connector, and may provide an opening the shape and dimensions of which correspond to the shape and dimensions of the opening of a fully open shut off valve normally suitable for deployment in the pipeline network.

Advantageously, a mounting means is provided for releasably mounting the device or the riser closure member in the riser and the seal is a seal means situated between an inner surface of the riser and an outer surface of the mounting means, the mounting means and the riser each including a part of a locking means for releasably locking the device in the riser, the device situated in the pipeline connector.

The seal situated between an inner surface of the riser and an outer surface of the mounting means comprises a plurality of spaced apart seal elements.

Preferably, the mounting means provides for the riser closure member or the device to be removed from or introduced into the housing with the pipeline under pressure. This may be done using the apparatus and method described in patent number GB2517308.

The mounting means may comprise a casing, the casing mounting one part of the locking means, and first and second seal means, wherein the first seal means provides a seal between the outer surface of the casing and the inner surface of the riser, and the second seal means is situated between the outer surface of casing and the inner surface of the pipeline connector.

The outer surface of the casing and the inner surface of the pipeline connector correspond in shape in the region of the second seal means.

The casing includes an opening and the second seal means is mounted around the opening between the casing and the pipeline connector, the opening providing a fluid pathway through the pipeline connector.

The casing includes an end member so shaped and dimensioned as to fit in a recess located in the pipeline connector.

The casing may comprise a first casing part and as second casing part, the first casing part mounting the at least one sensor and the second casing part situated in the riser above the first casing part.

Preferably, the part of the locking means located in the mounting means is situated in the second casing part.

Advantageously, the mounting means comprises a casing part connector located between the first and second casing parts, which first and second casing parts are each attached to the casing part connector.

The first seal means may comprise at least one first seal element and the at least one first seal element is situated between the casing part connector and the inner surface of the riser.

The first seal means may comprise at least two first seal elements and wherein at least one first seal element is situated between the outer surface of the second casing part and the inner surface of the riser.

The or each device may be mounted in an instrument housing, which housing is attached to the mounting means.

Preferably, the mounting means includes a fishing neck and the apparatus may further comprise a coupling configured to attach to the mounting means and to receive a closure cap thereon.

Advantageously, the pipeline network comprises a multiplicity of housings.

The riser closure member or housing may be instrumented and may be connected with communication means, for example using a mobile phone network or the internet. Instrumentation of the riser closure member or housing provides for the pipeline network operator to be furnished with information indicating what is in any particular housing. Such instrumentation may provide other information, such as location, identification, etc.

When a pipeline network operator wants to gather some data at a particular point in the network, one or more of the housings in the part of network concerned may be provided with a device, such as a sensor, a pump, a generator. Such a sensor may be configured for sensing a parameter selected from the group comprising: flow, temperature, chemical and bacteria content, dissolved oxygen, pH, oxidation reduction potential, conductivity, colour, turbidity, and pressure.

A second aspect of the invention provides a method of operating a pipeline network comprising the steps of:
providing a pipeline network according to the first aspect of the invention;
providing devices configured for insertion into at least one the housing;
monitoring the pipeline network; and
inserting a selected device into a selected housing of the network.

The method may include the step of removing a selected device from a selected housing.

The selected device may be a monitoring device and the method may include the step of monitoring an output of the monitoring device.

### BRIEF DESCRIPTION OF THE DRAWINGS

In the Drawings, which illustrate preferred embodiments of the invention:

FIG. 1 is a schematic representation of a pipeline network according to the invention;

FIG. 2 is a cross-sectional elevation of a housing forming part of the pipeline network illustrated in FIG. 1;

FIG. 3 is a cross-section elevation of the housing illustrated in FIG. 2 with a device mounted in the housing;

FIG. 4 is a cross-section elevation of an embodiment including the housing illustrated in FIG. 2 with a valve mounted in the housing using a bonnet arrangement;

FIGS. 5a to 5d illustrate the housing and valve arranged side by side is a plan view of the closure member illustrated in FIG. 4; and

FIG. 6 is a cross-section through a housing closure member for attachment to the housing of the embodiment illustrated in FIG. 4.

### DETAILED DESCRIPTION OF THE PREFERRED EMBODIMENTS

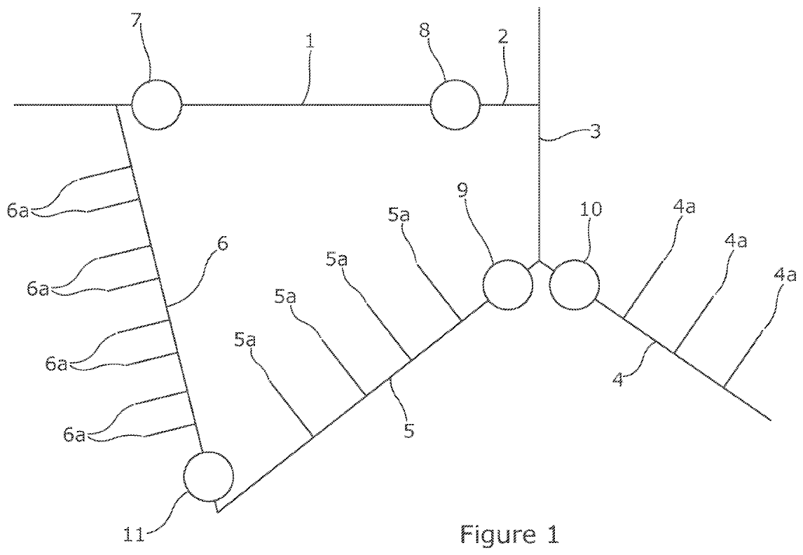

Referring now to FIG. 1, the pipeline network comprises a plurality of pipe lines 1-6 and a plurality of housings 9 to 11, connected to the pipe lines 1-6 for the passage of fluid therethrough and adapted to receive devices for interacting with fluid flowing through the pipelines 1-6.

In normal operation of the pipeline network, the housings 9 to 11 are sealed against egress of fluid therefrom but do not contain a shut off valve or other device for monitoring fluid flowing through the pipelines 1-6 or interacting actively with fluid flowing through the pipeline. In pipeline networks of the prior art each housing 9 to 11 would be a shut of valve or the like.

As can be seen from FIG. 1, the pipelines 4 to 6 have secondary pipelines 4a, 5a and 6a branding therefrom, for example to individual properties adjacent the pipelines 4 to 6. In the event that there is a leak in the pipeline 5, the housings 9 and 11 may be provided with valve inserts, those valve inserts being turned to shut off flow to the pipeline 5. In such an event the arrangement of housings means that water can still flow to the pipelines 1 to 4 and pipeline 6. When the leak has been repaired the valve inserts are removed for use in other parts of the pipeline network.

The valve (or other device) insert may be introduced into and removed from the housing 7 with the pipeline under pressure using the apparatus and method described in GB2517308, which is incorporated herein by reference.

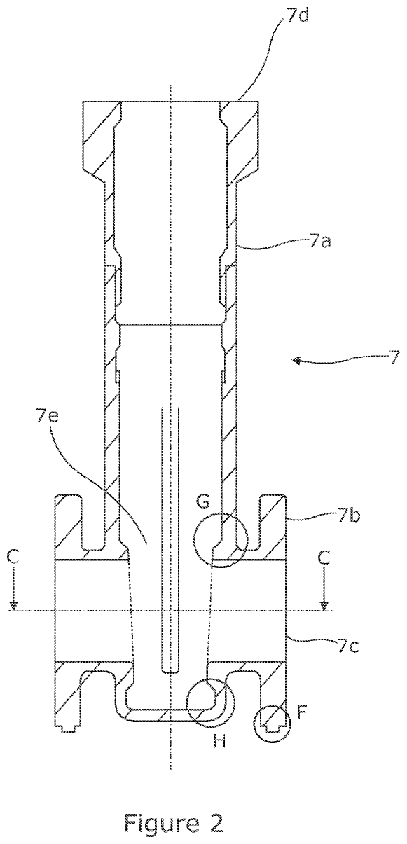

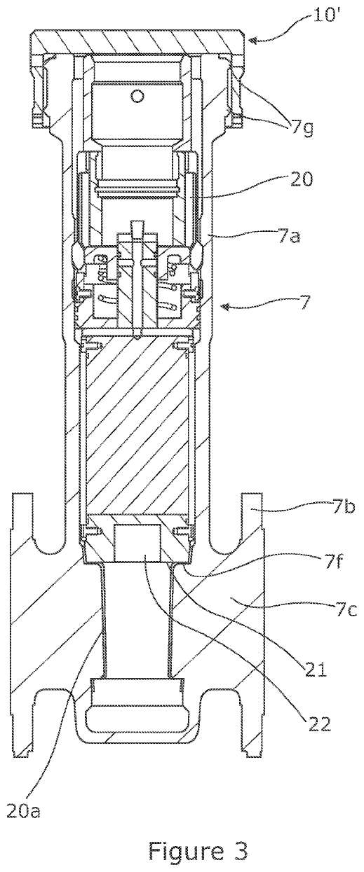

Referring to FIGS. 2 and 3, the housing 7 comprises a pipeline connector 7b and a riser 7a. The pipeline connector 7b provides a fluid passageway 7c which aligns with and is connected to the pipeline 1. The riser 7a has an upper surface 7d to which a cap 10 may be attached. The cap is fastened to the riser 7a by engagement of the wall of cap 10 with ridges 7e formed in the outer wall of the riser 7a. passing through holes 10a in the cap 10. The cap 10 includes a recess 10b for receiving a seal which seals against an inner surface of the riser 7a.

In its simplest form the housing 7 is empty and sealed by the cap 10. However, it may be desirable to close off the riser 7a at its intersection 7e with the pipeline connector 7c. A blanking element may therefore be provided for engaging with and closing off the riser 7a at the intersection 7e. This may be achieved by an insert which resembles closely a valve insert and attaches to the housing in the same way (typically as described in GB2559998 or WO2014020358, but which does not include any closure member. Hence, a through opening having a shape that is substantially the same as the shape an opening provided by a valve in an open state may be provided. One of the advantages of such an arrangement is that the only moving parts are those that attach the valve insert to the housing. There is no spindle a valve gate to seize up. Also, the shape of the fluid passage way provided by such an insert may cause less turbulence than if the pipeline connector 7c were empty.

FIG. 3 illustrates the housing 7 with a device 20 inserted therein. As can be seen from FIG. 3, a portion 20a of the device is situated in the fluid flow path through the pipeline connector 7c. The portion 20a may comprise a shut off valve, a monitoring device, a pump, etc, or the portion 20a may be empty.

The device 20 may be a simpler version of that illustrated in FIG. 3, in the form of a removable blank insert, the function of which is simply to prevent egress of fluid from the pipeline through the riser 7a. Such a device may include the same portion 20a, but without any shut-off valve or other device mounted therein. Alternatively, such a device may terminate at the point 7f where the riser 7a joins the pipeline connector, preferably presenting a smooth surface in the fluid passageway 7c. The smooth surface may be present by the lower face 21 of the device 20. Further, the lower wall 21 may include a recess 22 in which a sensor may be mounted. The recess is preferably closed so that the lower wall 21 presents a smooth surface.

It is preferred that the housing 7 and device 20 are in the form of a pipeline apparatus as described in GB2559998 or WO2014020358 which are incorporated herein by reference.

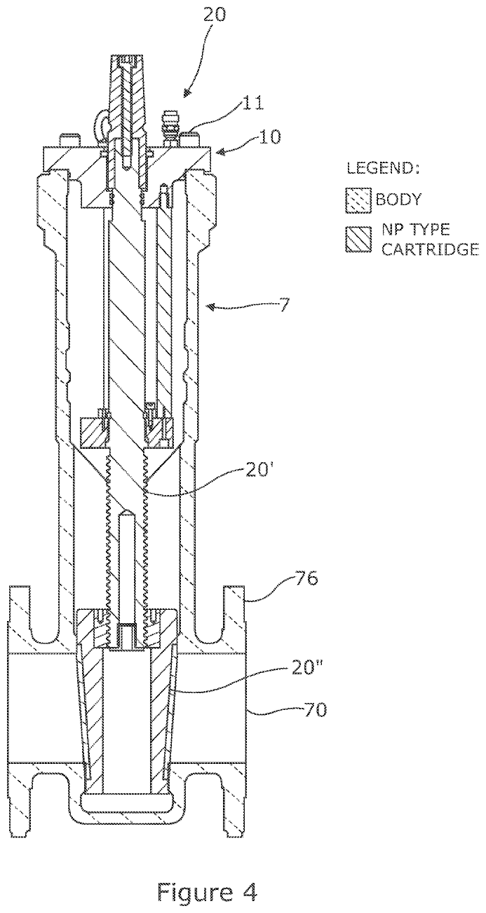

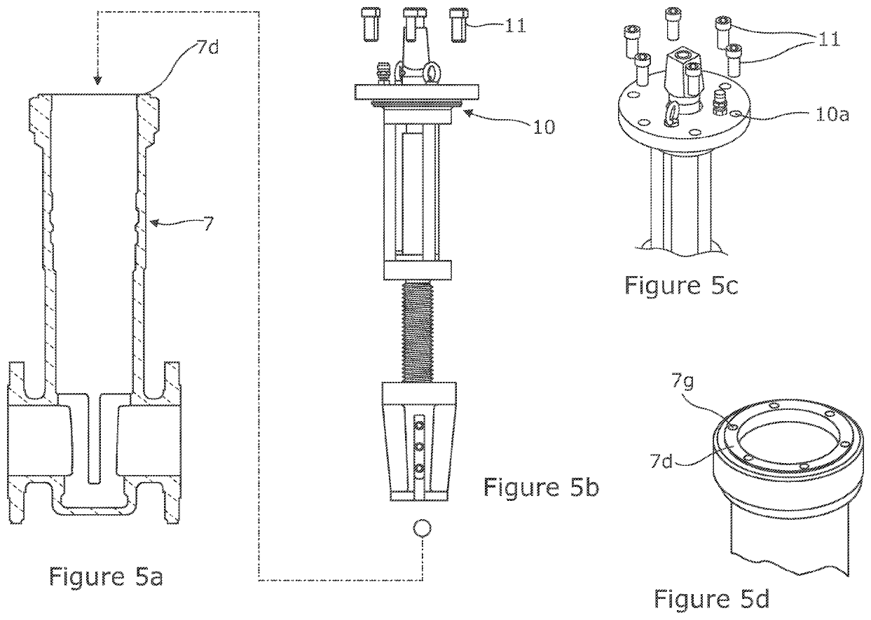

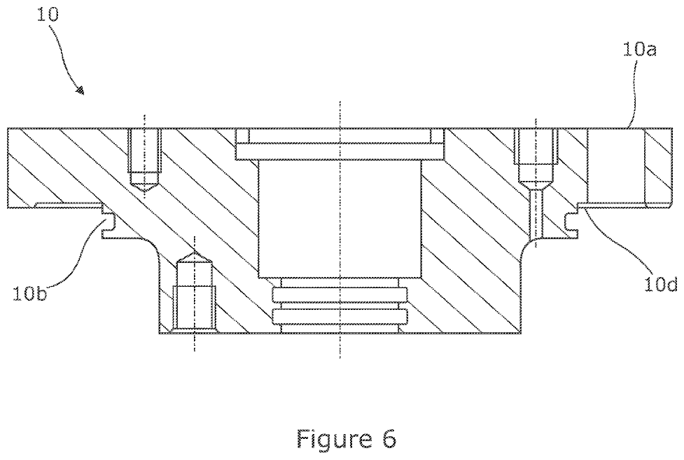

The pipeline network of the invention is not limited to the pipeline apparatus described in GB2559998. The device 20 may be configured with a bonnet attachment rather than using the attachment system described in GB2559998. In FIGS. 4 to 6, the housing 7 is configured such that it may be sealed with a bonnet 10, which sits on the upper surface 7d and is attached thereto by screws 11, which pass through holes 10a in the bonnet 10. The bonnet 10 includes seal 10c situated in recess 10b. The bonnet 10 includes a further recess 10d on its underside, the wall of the housing 7 being situated in the recess 10d such that the upper surface 7d is pulled tightly against the under side of the bonnet 10 by screws 11. The device 20 illustrated in FIGS. 4 to 6 is of the common bonnet valve construction comprising a spindle 20′ and valve 20″. Rotating the spindle 20′ causes the valve 20″ to be raised or lowered depending on the direction of rotation of the spindle 20′.

The pipeline network may also include traditional bonnet valves. Particularly in the case of upgrading of an existing pipeline networks it is likely that the network would include traditional bonnet valves as well as one or more housings and the associated devices for interacting with fluid flowing therethrough and riser closure members.

1-28. (canceled)

29. A pipeline network including at least one housing comprising a riser and a pipeline connector, the housing adapted to receive a device configured to interact with fluid flowing through the pipeline connector, the device removable from the housing, the riser provided with a riser closure member that is attachable removably to the riser, and a seal adapted to provide a fluid tight seal against egress of fluid from the pipeline connector via the riser wherein the at least one housing has attached thereto a selected one of the device and the riser closure member.

30. A pipeline network according to claim 1, wherein the riser closure member comprises an insert that is removably attachable to the riser.

31. A pipeline network according to claim 1, wherein the insert is shaped and dimensioned such that the riser is closed to the pipeline and the fluid pathway through the pipeline connector is similar to the shape and dimension of the opening when fully open of a fully open valve suitable for deployment in the pipeline network.

32. A pipeline network according to claim 1, wherein the riser includes a riser foot which opens up into the pipeline connector.

33. A pipeline network according to claim 4, wherein the riser closure member includes a blanking element.

34. A pipeline network according to claim 5, wherein the blanking element is configured to close off the foot of the riser.

35. A pipeline network according to claim 6, wherein a seal is provided between the blanking element and the wall of the housing at the foot of the riser.

36. A pipeline network according to claim 5, wherein the blanking element extends into the pipeline connector.

37. A pipeline network according to claim 8, wherein the blanking element provides an opening the shape and dimensions of which correspond to the shape and dimensions of the opening of a fully open shut off valve suitable for deployment in the pipeline network.

38. A pipeline network according to claim 1, wherein a mounting means is provided for releasably mounting one of the device and the riser closure member in the riser and the seal is a seal means situated between an inner surface of the riser and an outer surface of the mounting means, the mounting means and the riser each including a part of a locking means for releasably locking the device in the riser.

39. A pipeline network according to claim 10, wherein the device is situated in the pipeline connector.

40. A pipeline network according to claim 1, wherein the mounting means provides for one of the blanking element and the device to be a selected one of: removed from and introduced into, the housing with the pipeline under pressure.

41. A pipeline network according to claim 11, wherein the mounting means comprises a casing, the casing mounting one part of the locking means, and first and second seal means, wherein the first seal means provides a seal between the outer surface of the casing and the inner surface of the riser, and the second seal means is situated between the outer surface of casing and the inner surface of the pipeline connector.

42. A pipeline network according to claim 13, wherein the outer surface of the casing and the inner surface of the pipeline connector correspond in shape in the region of the second seal means.

43. A pipeline network according to claim 13, wherein the casing includes an opening and the second seal means is mounted around the opening between the casing and the pipeline connector, the opening providing a fluid pathway through the pipeline connector.

44. A pipeline network according to claim 13, wherein the casing includes an end member so shaped and dimensioned as to fit in a recess located in the pipeline connector.

45. A pipeline network according to claim 13, wherein the casing comprises a first casing part and a second casing part, the first casing part mounting the at least one sensor and the second casing part situated in the riser above the first casing part.

46. A pipeline network according to claim 17, wherein the part of the locking means located in the mounting means is situated in the second casing part.

47. A pipeline network according to claim 17, wherein the mounting means comprises a casing part connector located between the first and second casing parts, which first and second casing parts are each attached to the casing part connector.

48. A pipeline network according to claim 11, wherein the device is mounted in an instrument housing, which housing is attached to the mounting means.

49. A pipeline network according to claim 1, wherein the mounting means includes a fishing neck.

50. A pipeline network according to claim 1, wherein the apparatus further comprises a coupling configured to attach to the mounting means and to receive a closure cap thereon.

51. A pipeline network according to claim 1 and wherein at least one housing is configured for attachment of a bonnet thereto.

52. A pipeline network according to claim 1, the pipeline network comprising a multiplicity of housings.

53. The pipeline network according to claim 1, including at least one bonnet valve providing for shut off of a part of the pipeline network.

54. A pipeline network according to claim 1, wherein the riser closure member is instrumented and connected with communication means, for example using a mobile phone network or the internet.
